(19) United States
(12) Patent Application Publication
(10) Pub. No.: US 2004/0135879 A1
(43) Pub. Date: Jul. 15, 2004

(54) Portable wireless indoor/outdoor camera

(76) Inventors: Marco A. Stacy, Hampton, VA (US); Randy Hill, Hampton, VA (US)

Correspondence Address: Richard C. Litman, LITMAN LAW OFFICES, LTD., P.O. Box 15035, Arlington, VA, 22215, US

(21) Appl. No.: 10/750,853

(22) Filed: Jan. 5, 2004

Related U.S. Application Data
(60) Provisional application No. 60/437,753, filed on Jan. 3, 2003.

(51) Int. Cl. H04N 7/14

(52) U.S. Cl. 348/14.02

(57) ABSTRACT

A portable wireless video system comprises a pan and tilt mechanism supporting a video camera, and remote wireless mechanism in electronic communication with the pan and tilt mechanism and video camera. The remote wireless mechanism includes a video transmitter for transmitting video signals generated by the video camera and communicated to the remote wireless mechanism. A portable wireless terminal has a receiver and a display for displaying sequenced images from the video signal. The portable wireless terminal also includes a keypad for generating pan and tilt commands which are transmitted to the remote wireless mechanism, which in turn controls the pan and tilt mechanism in response thereto. The camera may be mounted to the top of a tall mast and the video signals may be conveyed to the portable wireless terminal via a cellular phone network.

### CROSS-REFERENCE TO RELATED APPLICATION

This application claims the benefit of U.S. Provisional Patent Application Serial No. 60/437,753, filed Jan. 3, 2003.

### BACKGROUND OF THE INVENTION

1. Field of the Invention

The present invention relates to a method and apparatus for wireless video monitoring of an area or activity.

2. Description of the Related Art

Young children require considerable amounts of care and supervision. Parents of young children often have full time jobs as well as other demands on their time. To help parents of young children a child care industry has built up. Nanny and au-pairs are often employed by parents to look after young children. Unfortunately, not all nannies or au-pairs are created equal and some are less good at their job than others, and some commit criminal acts against the children they are hired to care for. Sometimes a parent might think a nanny is being cruel to their child, but absent obvious signs of abuse a parent can be left in a difficult situation as to the best cause of action.

Some parents arrange their lives so that at least one parent is always at home or on hand to supervise and look after their children. However, there have been cases where young children have been snatched at night while sleeping in their bedroom. Thus, there is a need for a way of checking on the well-being of a child even when both parents are present in the home.

A parent may spend inordinate amounts of time traveling as part of their job but would like to feel that they are still connected to their child. Pictures placed in wallets or purses help, but pictures represent but a fleeting moment in a child's life. Thus, there is a need for a device or system that enables a parent to remotely view their child while traveling, e.g. on a long train journey. Such a device should preferably prevent unauthorized persons such as pedophiles, opportunistic and accidental voyeurs also viewing the child or a legitimate but otherwise private family occasion or activity.

When a homeowner or lessee travels away from their home, they can feel some level of anxiety about the well-being of their property or e.g. a pet animal. A means of remote viewing, and preferably a secure means for remote viewing, of their home from any location is desirable to help alleviate such anxiety.

In addition, there is a growing need for real time monitoring of people and activities in all sorts of settings. For example, there is a considerable interest in coaching football and baseball teams. Coaching teams of young athletes to work as a team is difficult. A coach will inevitably look in a particular direction during play. For example, the less expert coach might selectively watch the players by following the ball instead of looking at the team as a whole. Individual team member responses remain critical throughout the game regardless of the position of the ball or play. Even if a coach tries to view the whole team, this might prove difficult, particularly if the coach is located on a side-line at ground level. Thus, there is a need for improving the ability of a coach to monitor the performance of all individuals in a team.

Placing permanent video coverage along a street or over a public area can cause a lot of unease, particularly for residents who live along the street. Civil rights and conspiracy theorists often complain that placing video cameras in public streets is undesirable on privacy or “big brother is watching you” grounds. Regardless of countless arguments that a reasonable person does not have a reasonable expectation of privacy while e.g. walking along a public street, the fact remains that many members of the public can feel unease and discomfort at the thought that cameras may be placed permanently along public streets and parks. However, there are times when video monitoring of a public area is required during, e.g., an otherwise peaceful and legal demonstration known to be vulnerable to infiltration by anarchist groups of individuals bent on causing mayhem and destruction to property. Thus, there is a need for a means of video monitoring that is simple and easy to erect and take down thus solving the problem of over intrusive video monitoring of public streets.

In addition, there is a need for real time monitoring of individuals inside buildings such as a baby or young child in a family dwelling. A parent may have a video camera that lacks the ability to pan and tilt. Thus, there is a need for a platform adapted to pan and tilt the camera, and provide a wireless communication capability to enable a parent to remotely monitor their baby over a short or long distance.

Several efforts have been made to address these and other problems. U.S. Patent Publication No. 2002/0012050 (“the '050 publication”), published Jan. 31, 2002, shows an image pickup system comprising a commander, a video camera and a display device in the form of a view finder with a small display such as a liquid-crystal display. The display device is incorporated into a head set. The head set also comprises a microphone. A user may look at images displayed in the view finder and have the microphone pick up his own voice for transmission and integration with video recorded by the camera. The device described in the '050 publication is not suitable for long distance remote viewing. The device described in the '050 publication is also not suitable for providing an elevated video view of e.g. a student marching band practicing on a school field.

U.S. Pat. No. 6,161,933, issued Dec. 19, 2000 to Tschida et al., describes a device for controlling, regulating and monitoring a cine camera. The '933 patent does not teach or suggest an elevated means for monitoring an activity or area, nor does the '933 patent teach or suggest adapting a camera to verify and accept a cell call for secure transmission of a continuous real time video of an area or activity over a long distance as envisaged in the present invention.

U.S. Pat. No. 5,079,634, issued Jan. 7, 1992 to M. Hosono, describes an apparatus for wireless-controlling a camera integral with a VTR (video tape recorder) and an apparatus for two-direction simultaneous control of an electrically-driven device for use with this camera wireless control apparatus including a display. The '634 patent to Hosono is distinguishable from the present invention in several important respects. For example, the '634 patent does not show a video camera in combination with a tall supporting mast. In addition, the '634 patent does not show a video camera adapted to receive a cell phone request for continuous video for cellular transmission to a remote location that could be thousands of miles away from the video camera.

U.S. Pat. No. 5,414,444, issued May 9, 1995 to D. M. Britz, shows a personal communicator having an “orientable video imaging element”. The '444 patent to Britz does not show a video camera under the independent control of a separate controller wherein the separate controller, which may be a cell phone adapted to act as the controller, can cause the video camera to pan and tilt. Neither does the '444 patent show a secure means for receiving a cell phone call adapted to automatically trigger the transmission of video to another cell phone with, e.g., G4 technology to display the transmitted video.

Other patents showing devices for hand related devices but which do not solve the above mentioned problems include U.S. Pub. No. US 2002/0097332 A1, published Jul. 25, 2002 (a system for omnidirectional image viewing at a remote location without the transmission of control signals); U.S. Pub. No. US 2002/0015095 A1, published Feb. 7, 2002; U.S. Pat. No. 4,097,893, issued Jun. 27, 1978 to M. Camras (portable video recording system employing a camera and a recording station connected by wireless links); U.S. Pat. No. 4,928,179, issued May 22, 1990 to Takahashi et al. (video camera capable of effecting remote control operation); U.S. Pat. No. 4,974,088, issued Nov. 27, 1990 to T. Sasaki (remote control apparatus for a rotating television camera base); and U.S. Pat. No. 5,065,249, issued Nov. 12, 1991 to Horn et al. (a portable video camera/monitor support).

Further patents showing devices for hand related devices but which do not solve the above mentioned problems include U.S. Pat. No. 5,382,943 issued Jan. 17, 1995 to M. Tanaka (a remote monitoring unit); U.S. Pat. No. 5,528,264 issued Jun. 18, 1996 to Kautzer et al. (a wireless remote control for electronic equipment); U.S. Pat. No. 5,594,498 issued Jan. 14, 1997 to W. C. Fraley (a personal audio/video surveillance system); U.S. Pat. No. 5,752,112 issued May 12, 1998 to Paddock et al. (a mounting system for body mounted camera equipment); U.S. Pat. No. 6,027,257 issued Feb. 22, 2000 to Richards et al. (a pan and tilt unit); U.S. Pat. No. 6,056,450 issued May 2, 2000 to D. R. Walling (a camera support device with a telescoping pole and monitor); and U.S. Pat. No. 6,164,843 issued Dec. 26, 2000 to G. Battocchio (a tripod particularly for photographic uses).

Still other patents showing devices for hand related devices but which do not solve the above mentioned problems include U.S. Pat. No. 6,244,759, issued Jun. 12, 2001 to R. Russo (an adjustable camera support); U.S. Pat. No. 6,293,676, issued Sep. 25, 2001 to J. Holway (a camera support including extendable post); U.S. Pat. No. 6,439,515, issued Aug. 27, 2002 to A. D. Powers (a video camera support device); U.S. Pat. No. 6,445,410, issued Sep. 3, 2002 to K. Kawano (an image input apparatus); Japanese Patent Nos. JP3-265376, and JP4-284435; and European Patent Publication Nos. 578,183, and 656,719.

None of the above inventions and patents, taken either singly or in combination, is seen to describe the instant invention as claimed.

### SUMMARY OF THE INVENTION

A portable wireless video system includes a pan and tilt mechanism supporting a video camera, and remote wireless mechanism in electronic communication with the pan and tilt mechanism and video camera. The remote wireless mechanism includes a video transmitter for transmitting a video signal generated by the video camera and communicated to the remote wireless mechanism. A portable wireless terminal has a receiver and a display for displaying sequenced images from the video signal. The portable wireless terminal also includes a keypad for generating pan and tilt commands which are transmitted to the remote wireless mechanism, which in turn controls the pan and tilt mechanism in response thereto. The camera may be mounted to the top of a tall mast and the video signals may be conveyed to the portable wireless terminal via a cellular phone network.

Accordingly, it is a principal object of the invention to provide a portable wireless video monitoring system and method for coaching students.

It is another object of the invention to provide a portable wireless video monitoring system which may be used to monitor a child's bedroom or play area for security purposes.

It is a further object of the invention is to provide a portable wireless video monitoring system as a video link between a traveling away from home parent and their child.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a portable wireless video monitoring system configured for elevated video monitoring of a group activity according to the present invention.

FIG. 2 is a schematic diagram of a portable wireless video monitoring station according to the present invention.

FIG. 3 is a schematic diagram of an alternative portable wireless video monitoring station according to the present invention.

FIG. 4 is an elevation view of the portable wireless monitoring station of FIG. 3.

FIG. 5 is a perspective view of a height adjustable mast according to the present invention with at least one video monitoring station of FIG. 2.

FIG. 6 is a perspective view of another height adjustable mast according to the present invention.

FIG. 7 is an end view of one section of a telescoping mast in a portable wireless video monitoring system according to the present invention.

FIG. 8A is a top view of a mobile terminal according to the present invention.

FIG. 8B is a side view of the mobile terminal of FIG. 8A.

FIG. 9 is a schematic view of the internal components of the mobile terminal of FIG. 8A.

FIG. 10 is a flow chart showing the steps of a voice recognition algorithm according to the invention.

FIG. 11 shows a diagrammatic overview of a cellular enabled video monitoring system according to the present invention.

FIG. 11A is a schematic diagram of a cellular enabled video monitoring system.

FIG. 12 is a front view of a mobile terminal in the form of a cell phone adapted to display video according to the present invention.

FIG. 13 is a flow chart of a firewall for controlling access to a video monitoring station according to the present invention.

Similar reference characters denote corresponding features consistently throughout the attached drawings.

### DETAILED DESCRIPTION OF THE PREFERRED EMBODIMENTS

The present invention relates to a portable wireless video monitoring system and method for wireless video monitoring of an area or activity, such as a child's bedroom or play area in a home environment. The invention is particularly directed to coaching a group of students engaged in a physical activity such as band playing. The invention is more particularly directed to the use of different wireless communication technologies, such as conventional cellular technology and more advanced 3G enabled technology, in conjunction with video monitors.

Elevated Video System as a Coaching Aid

In this aspect of the invention, an elevated video system (“EVS E50”) configured for use as a coaching aid for team sports, marching bands and the like is described.

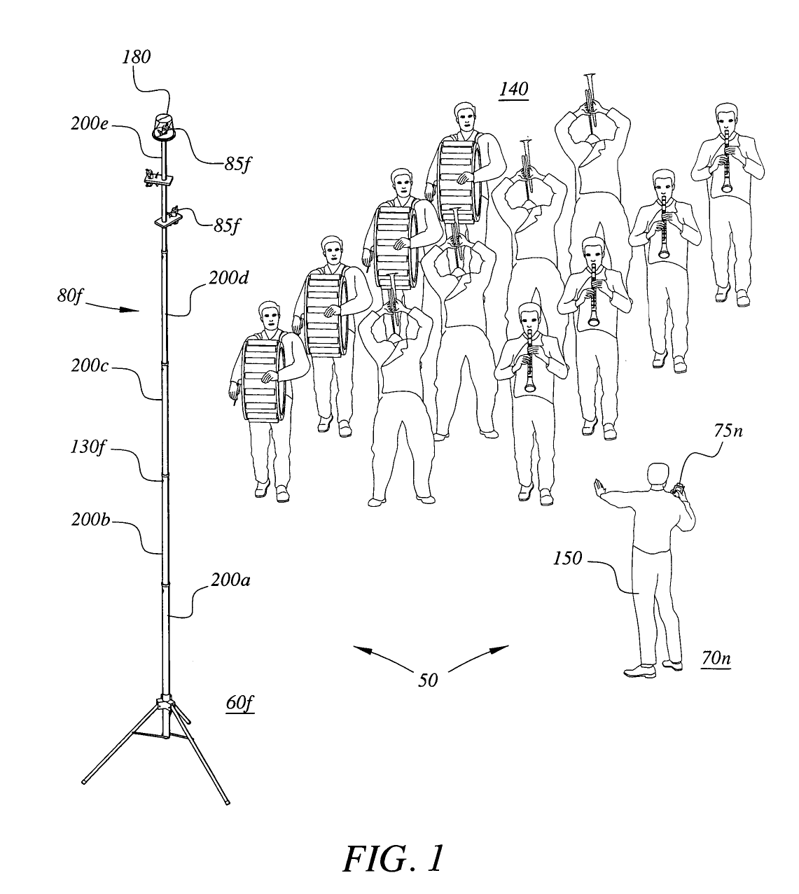

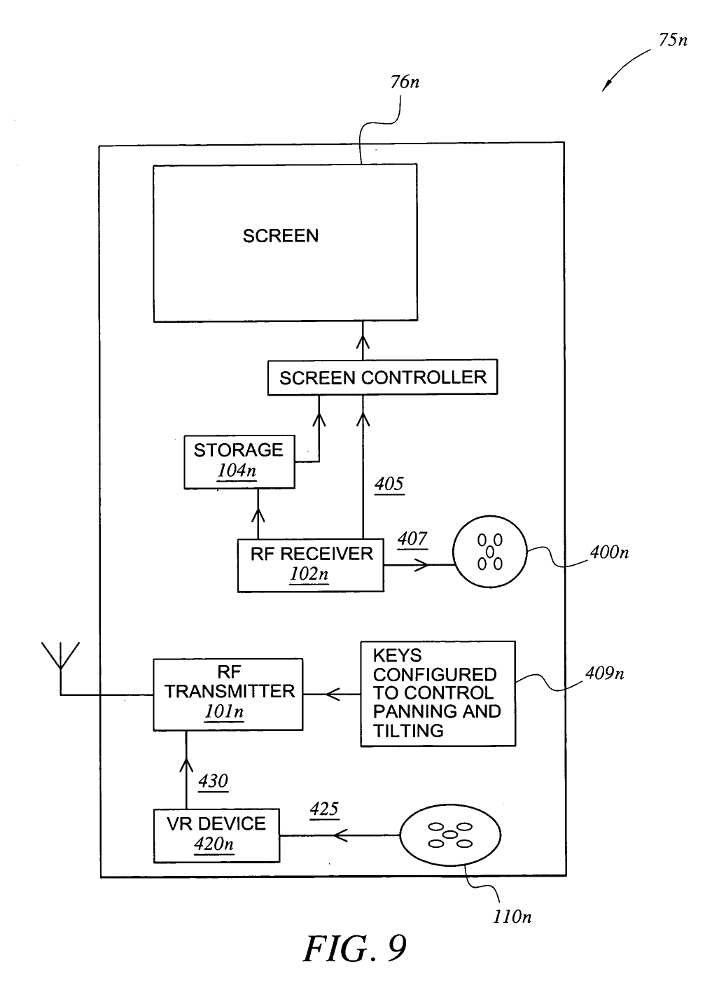

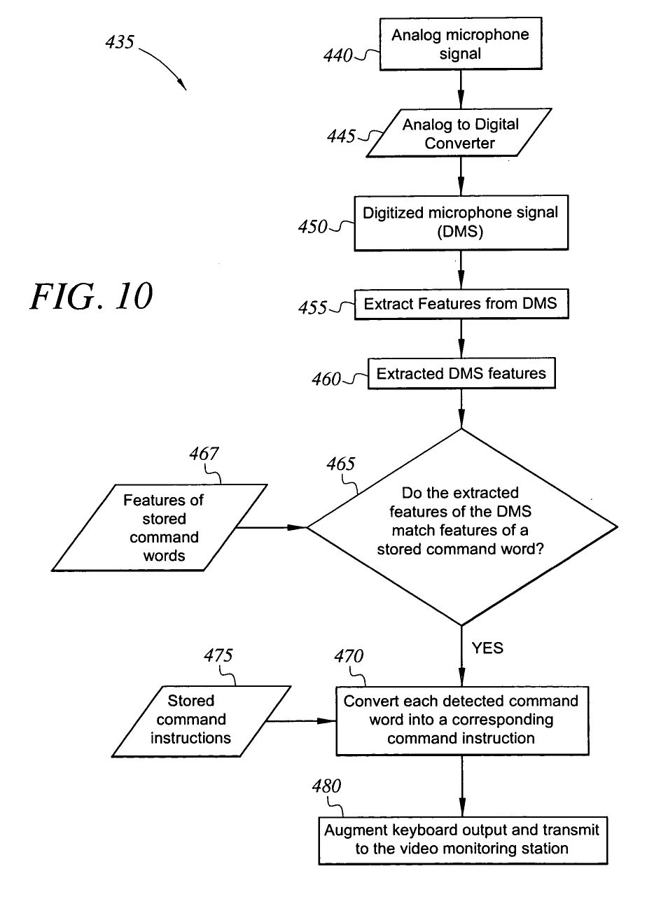

The EVS E50, designated generally as 50 in the drawings, is shown in FIGS. 1 through to FIG. 10. Broadly, the EVS E50 comprises a far side or remote terminal 60f, and a near side or operator terminal 70n. Generally, the far side 60f comprises a portable mast 80f fitted with at least one wireless video monitoring station 85f, and the near side 70n comprises a handheld portable terminal 75n adapted to wirelessly communicate with the wireless video monitoring station 85f and display video received therefrom on a screen 76n (see e.g. FIG. 9).

For ease of description, a reference number terminating with the letter “f” designates that the device is located on the far side 60 (i.e., 60f), and conversely a reference number terminating with the letter “n” indicates that the device so referenced is located on the near side 70 (i.e. 70n) of the EVS E50.

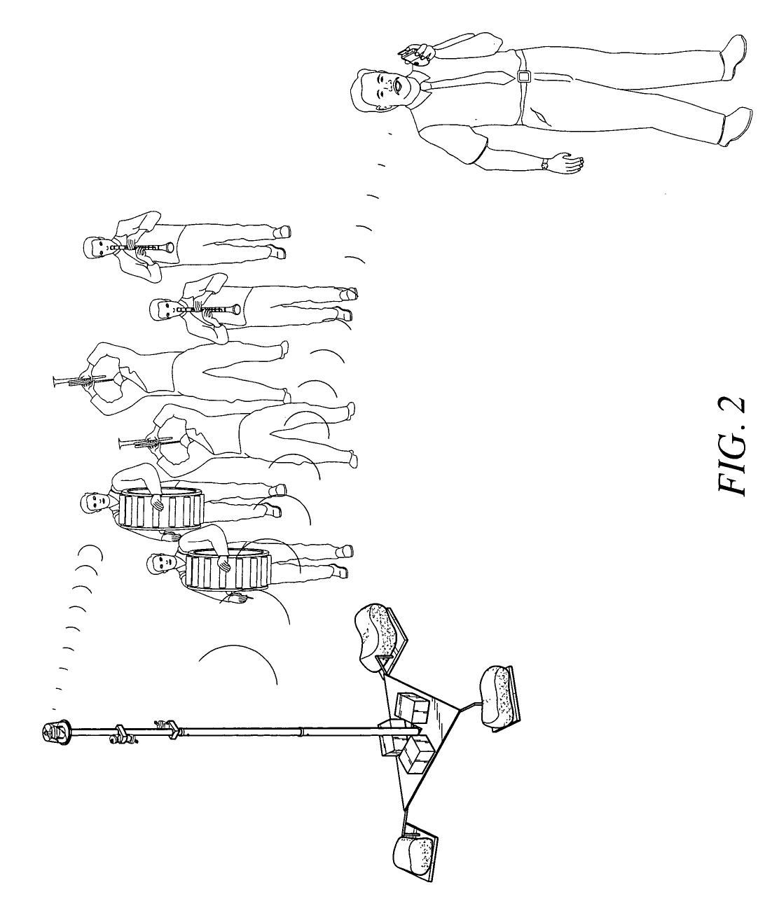

The far side wireless video monitoring station 85f preferably comprises a video camera 90f, a pan and tilt mechanism 95f, a control circuit 100f, a wireless transmitter 101f, and a wireless receiver 102f (see FIG. 2). The pan and tilt mechanism 95f is attached to the video camera 90f. The control circuit 100f is operably connected to the video camera 90f, the wireless transmitter 101f and receiver 102f. It should be understood that the wireless transmitter 101f and receiver 102f may be integrated and treated as a transceiver 103f.

The wireless video monitoring station 85f may further comprise an optional storage device 104f for storing video and/or audio. The storage device 104f may take various forms such as electronic or magnetic media, e.g. an electronic memory chip or a conventional hard-drive, respectively. The storage device 104f may be a VCR (video cassette recorder). In the cellular enabled embodiment of the wireless monitoring station 85f described below, the optional storage device 104f can play an important role in providing a smart download of video frames in instances where the local cellular network environment offers marginal or limited bandwidth for transmitting video frames to a cellular enabled handheld portable terminal 75.

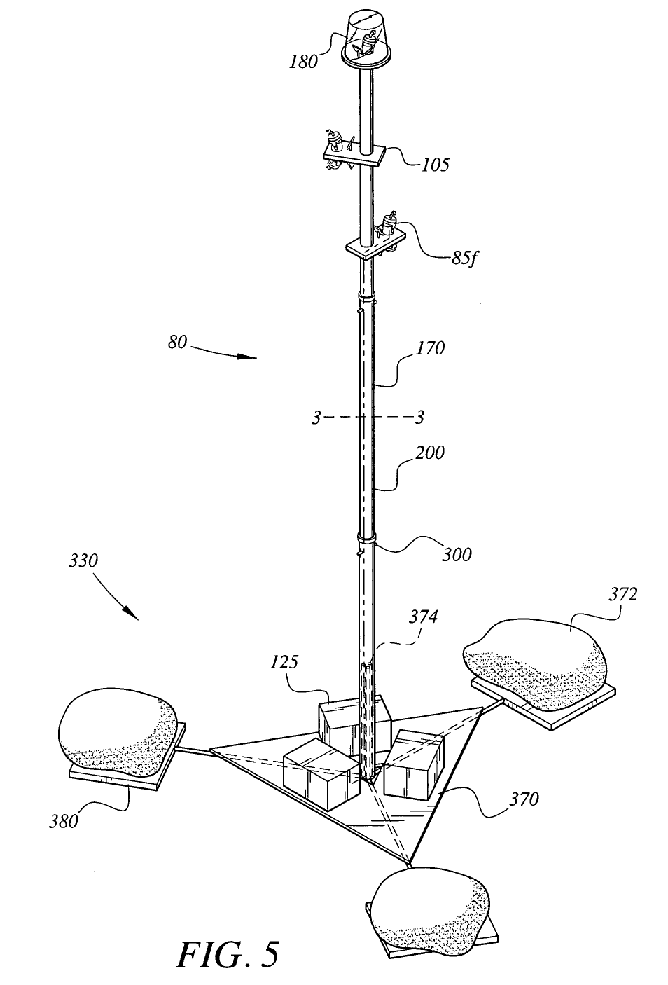

Each far side wireless video monitoring station 85f is preferably powered by at least one rechargeable battery, such as at least one twelve volt rechargeable battery 125 (see e.g. FIG. 5) or any suitable equivalent thereof. Also, each far side wireless video monitoring station 85f may further comprise an optional microphone 110f to provide a far side analog microphone signal for transmission to the near side handheld portable terminal 75n. The microphone 110f may be located a considerable distance away from the camera 90f thus helping to solve the problem that often occurs when a group activity such as a football or soccer game is too far away from the video camera 90f for a microphone to pick up sounds if the microphone is placed at the same location as the camera 90f. The analog microphone signal generated by the microphone 110f may be incorporated into the signal broadcast by the transmitter 101f to the handheld portable terminal 75n.

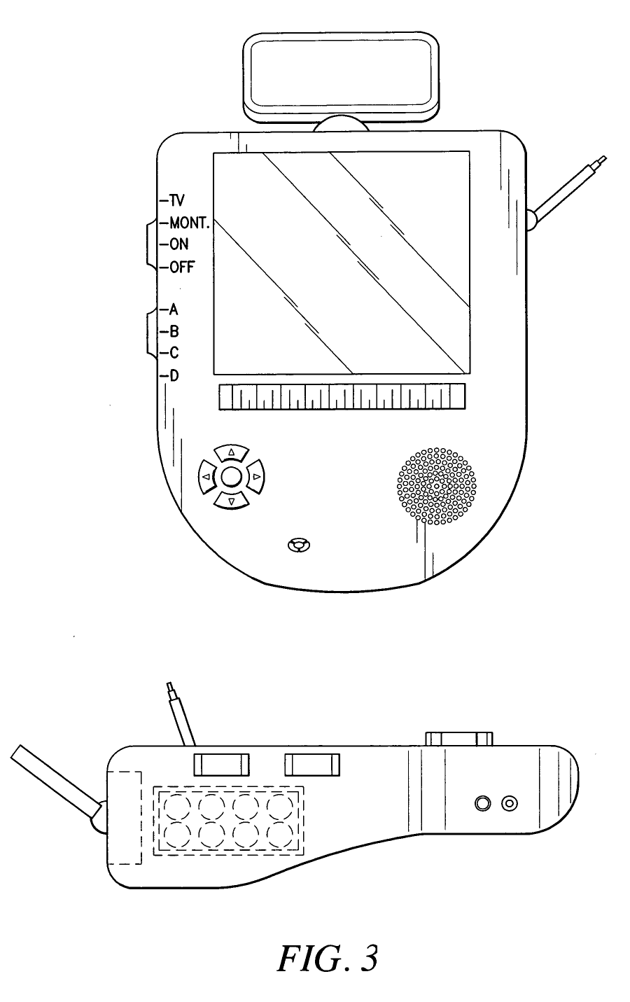

It should also be understood that the video camera 90f may be a standard video camera 90f′ separately coupled to a radio frequency (“RF”) transmitter 103f′ (see FIG. 3); in this embodiment of the invention the video camera 90f′ is not operably coupled to the control circuit 100f. Standard video cameras include a standardized adapter for attaching to standard tripod mounts, e.g., using shoe-plate or screw connections. Thus, the handheld portable terminal 75n cannot be used by a coach 150 to wirelessly adjust, for example, the focus of the camera 90f′, but can be used to adjust its viewing area by sending wireless command instructions to the pan and tilt mechanism 95f to pan and/or tilt the camera 90f′. Thus, a user may attach his/her own video camera 90f′ (preferably a camera with auto-focus) to the pan and tilt mechanism 95f and attach a video line between their camera 90f′ and the RF transmitter 101f′. In this embodiment, in order to output video originating from the video camera 90f′, the portable handheld terminal 75n would require a receiver 102n (see e.g. FIG. 9) tuned into the transmit frequency of the transmitter 101f′, and a transmitter 101n to transmit command instructions to the receiver 102f and then onto the pan and tilt mechanism 95f via the control circuit 100f.

The near side 70n comprises a handheld portable terminal 75n (see e.g. FIGS. 1, 8A, 8B and 9) adapted to receive and display wireless video originating from the far side wireless video camera 90f, and is further adapted to transmit command instructions to the far side wireless video monitoring station 85f to control the video camera 90f and the pan and tilt mechanism 95f. The EVS E50 preferably operates at 2.4 GHZ over a distance of up to about three hundred feet. The preference for the 2.4 GHZ frequency owes much to the current rules and regulations governing electromagnetic emissions. It should be understood that other frequencies may be used subject to a change to the rules and regulations governing electromagnetic emissions.

The wireless video camera 90f may take the form of an X10 wireless video camera, particularly a weather proofed X10 wireless video camera shown atop a mast 80f, as shown in, e.g., FIGS. 1 and 4-6. It should be understood that the pan and tilt mechanism 95f may take various forms, such as a remote controlled pan and tilt table used in the wireless VN-C30U video system supplied by JVC, and the well known NINJA Pan 'n Tilt X10 wireless video camera mount supplied by X10. A functional pan and tilt mechanism is described in U.S. Pat. No. 4,945,367, issued Jul. 31, 1990 to D. M. Blackshear, which is incorporated herein by reference in its entirety.

FIG. 1 shows an environmental, perspective view of one embodiment of the EVS E50. The far side comprises at least one wireless video monitoring station 85f mounted on a portable mast 80f in the form of a collapsible tripod 130f, which may be extended from about four feet up to about thirty feet. The near side 70n comprises a portable handheld terminal 75n adapted to wirelessly communicate with the wireless video monitoring station 85f.

Still referring to FIG. 1, at least one of the wireless video monitoring stations 85f provides an elevated view of a plurality of a group being coached, such as members of a high school marching band 140 practicing contemporary band playing. A coach 150 receives an elevated view of the band on a handheld terminal 75n. The coach 150 can send wireless command instructions via the handheld terminal 75n to a selected wireless video monitoring station 85f to cause a pan and tilt mechanism 95f to keep a video camera 90f pointed at the band 140 to provide a desired elevated view of the band 140.

The coach 150 sees an elevated view of the band 140 displayed on the near side mobile terminal 75n, thus supplementing a ground level view of the band 140. Specifically, the video of the band displayed on the mobile terminal 75n enables the coach 150 to quickly spot mistakes made, e.g., back row members of the band 140 marching out of step or an out of position member of the band 140.

More specifically, a coach 150 typically has problems coaching the whole group. For example, the coach 150 can see the outer or facing rows of a band 140 but might have great difficulty in getting an overall view of the band 140 while coaching at ground level. Still more specifically, line of sight limits the coach to monitoring the outer members of a multi-row group of band members, but with the video from the EVS E50 the coach 150 can simultaneously see outer members, middle position members and back row members of the marching band 140. Thus, as should now be apparent, the EVS E50 lends itself to an improved method of coaching.

The improved method of coaching comprises the step of providing a coach 150 with an elevated view of a plurality of members being coached, such as a high school marching band 140, wherein the coach is able to combine the elevated view of the band members with conventional line of sight ground level observations, thereby solving the problem that often besets coaches, the need for simultaneous monitoring of substantially all members of a band 140.

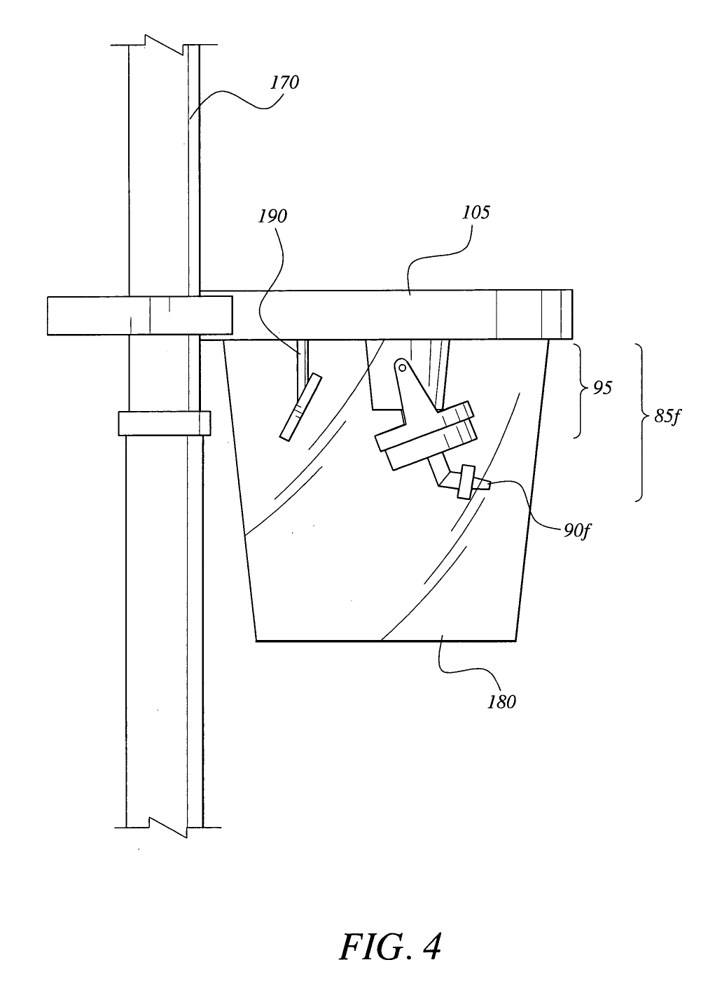

Referring to FIG. 4, a wireless video monitoring station 85f is shown attached to a support platform 105 affixed to a telescopic support column 170, which forms part of the mast 80f (see FIG. 5). The wireless video monitoring station 85f, along with its receive/transmit antenna 190, is housed in a protective shroud 180. The protective shroud 180 protects the wireless video monitoring station 85f from inclement weather. The protective shroud 180 can take any suitable form, including that of a transparent bubble, though it is preferred that the protective shroud 180 is made of a transparent polymer. It should be understood that the wireless video monitoring station 85f may be fitted in any suitable configuration to the mast 80f, e.g. upside down relative to platform 105 as shown in FIG. 4, or atop of the platform 105. It is preferred that at least one station 85f is attached to each mast 80f, i.e. more than one mast 80f may be used to provide the desired video coverage.

It is preferred that each wireless video monitoring station 85f is of optimum construction. Thus, with respect to the mast 80f, where overloading of the support column 170 must be avoided, the video camera 90f is preferably small and lightweight. Suitable examples of lightweight video monitoring stations 85f include the X10 systems, and more particularly the wireless VN-C30U video system supplied by JVC, and the NINJA Pan 'n Tilt X10 wireless video camera and pan/tilt system supplied by the X10 company.

Referring to FIGS. 1, 5, 6, and 7, the telescopic support column 170 comprises a series of hollow tubes 200 with progressively increasing diameters, so that the column 170 can be collapsed for portability and easy storage. The hollow tubes 200 are preferably made of tubes of high strength but lightweight metal, such as aluminum with a circular cross sectional area. Tubular aluminum is preferred on grounds of low cost while offering an excellent combination of strength and lightness. While circular cross section tubes are preferred, any suitable configuration may be used, e.g., the support column 170 may comprise of hollow square or rectangular steel tube sections. Alternatively, the tubes 200 may be made of a plastic or fiber glass to ensure lightness and resistance to weathering.

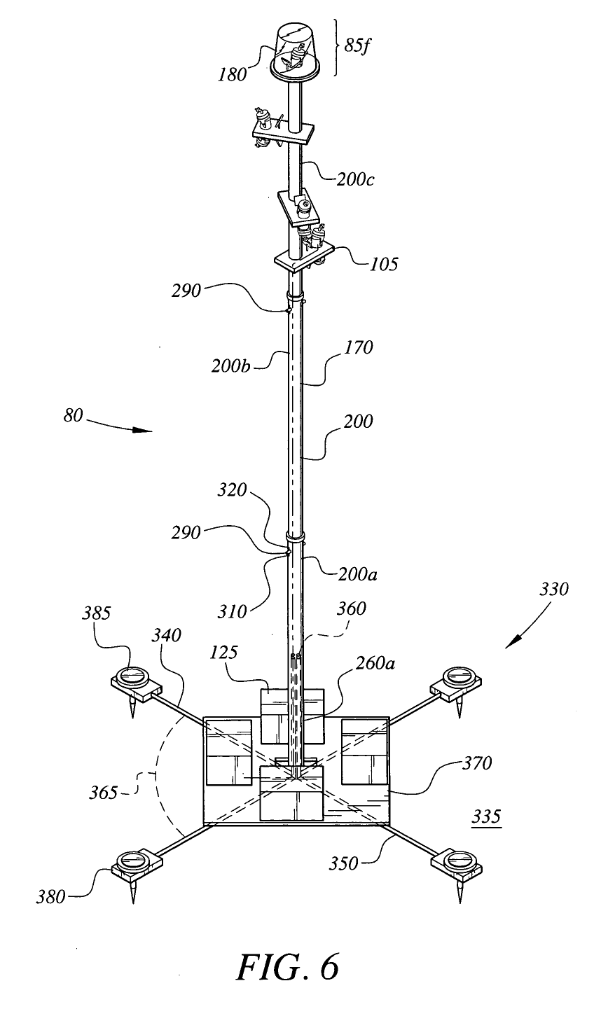

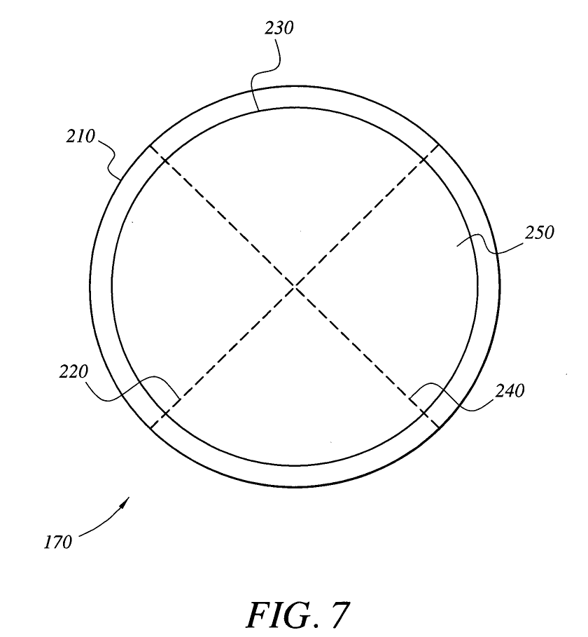

As shown in FIG. 7, each hollow tube 200 is preferably between about four feet and six feet in length with an external surface 210 defining an outer diameter 220, and an internal surface 230 defining an inner diameter 240 and further defining a hollow cylinder 250. Referring to FIGS. 1 and 6, a base hollow tube 200a has a predetermined inner diameter 240, a bottom end 260a and a top end (the numeric-alpha “a” signifying the base tube, thus e.g. “tube 200c” would signify a tube two sections removed from the base tube 200a and would fit into the tube 200b which would fit into base tube 200a).

The inner diameter 240 of the base tube 200a is chosen such that a second hollow tube 200b has a smaller outer diameter 220 than the inner diameter 240 of the base tube 200a. Thus, the second hollow tube 200b fits snugly inside the base tube 200a and can easily be extended therefrom with about a foot of length of the second tube 200b remaining in the top end of the base tube 200a.

This pattern of selected diameters is repeated for the remaining hollow tubes 200. For example, the inner diameter 240 of the second hollow tube 200b is chosen such that the outer diameter 220 of a third hollow tube 200c is slightly less than the inner diameter 240 of the second tube 200b. Thus, tube 200e fits flush inside tube 200d, and tube 200d fits flush inside tube 200c and so on. Thus, the tubes 200 may ultimately be collectively stacked in the base tube 200a in telescoping fashion.

In one embodiment of the invention, each tube 200 has an upper end adapted to accommodate a securing bolt 290 (see FIG. 6) which fits transversely through a pair of through-holes in the form of aligned apertures 300 and 310, respectively. The securing bolt 290 is held in place by a bolt securing pin 320. For additionally safety, the bolt 290 may have a bolt securing pin 320 at both ends of the bolt 290. Alternatively, one end of the bolt 290 is wider than at least one of the aperture holes 300 and 310, and therefore only requires one securing pin 320. Thus, each tube 200 can be extended from the previous tube 200 and is held safely in place without risk of the support column 170 collapsing.

The support column 170 is attached to a base 330 comprising a set of legs 335 in the form of right angle tubes 340, each of which comprise a first half 350 that straddles the ground 355 to define the base 330, and a second half 360 that fits inside the bottom end 260a of the base tube 200a. The optimum number of right angle tubes 340 is at least three, with an angle of separation of not more than about 120° (i.e. 360/n, where n is the number of right angle tubes 340 forming the base 330). Thus, for four right angle tubes 340, the angle of separation is about 90° (i.e. about 360/4 degrees)

The number of right angle tubes 340 is governed, in part, by the inner diameter 240a of the base tube 200a, since the hollow core or cylinder 250 must accommodate the second halves 360 of the right angle tubes 340. Obviously, the inner diameter 240 of base tube 200a should be sufficient to accommodate at least three second halves 360. It is well within the ordinary skill of the art to select the appropriate diameters of the component parts of the column 170 and base 330.

Optional cross plates 370 may be placed between or across pairs of right angle tubes 340, as shown in FIGS. 5 and 6. Heavy items, such as sand bags 372, may be placed on the cross plates 370 or directly on the ground portion 350 of the right angle legs 340 to provide extra stability to the mast 80. Batteries, such as twelve volt batteries 125, may be placed on the cross plates 370 to power the wireless video monitoring stations 85f via appropriate wiring. The batteries 125 also provide ballast thereby stabilizing the column 170 and thence mast 80f. The position of the battery 125 is not critical and may be housed inside shroud 180 and form part of the wireless video monitoring station 85f.

The cross plates 370 may have underside grooves (not shown) to serve the additional function of keeping the ground component 350 of the right angle tubes 340 at an appropriate degree of separation 365. Alternatively, flat plates 380 may be attached to the right angle tubes 340, as shown in FIGS. 5 and 6, and a stake or spike 385 driven through an aperture in each flat plate 380 and thence into the ground to add extra stability to the mast 80f and further maintain a reasonable degree of separation 365 between the ground portions 350 of the right angle tubes 340. Each spike 385 may comprise a flange end to stop the spike working loose from the legs 335 and detracting from the stability of the column 170. The spike 385 is preferably a separate fixture that is attached to the end of each right angle tube 340 and then driven into the ground 355. It should be understood that any suitable equivalent mast-securing device may be used to secure the mast 80f to the ground 355.

It should be understood that the support column 170 and base 330 may vary without detracting from the spirit of the invention. Thus, the bottom end 260a of base tube 200a may be inserted into a bearing ring 374 attached to legs terminating in flattened foot pads as described in U.S. Pat. No. 4,074,881 (“the '3881 patent”) issued Feb. 21, 1978 to G. L. Bickford, which describes a tripod assembly for receiving and holding a support column 170 (referred to in the '881 patent as a “standard 22”). The '881 patent is incorporated by reference herein in its entirety.

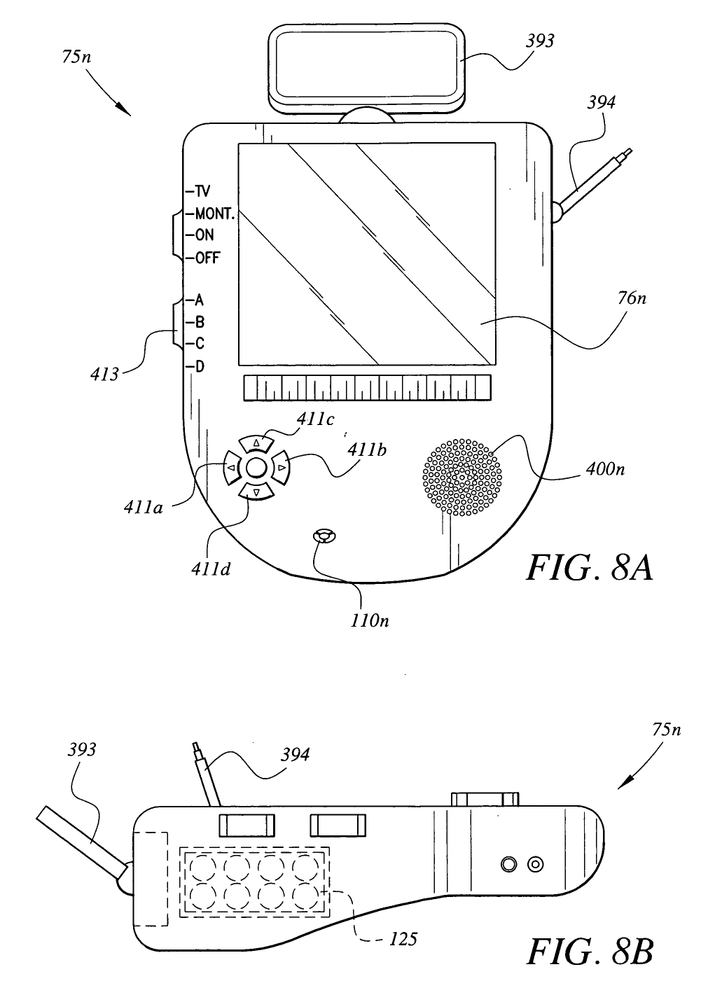

Referring to FIGS. 8A, 8B, and 9, the near side mobile terminal 75N comprises keys 411a, 411b, 411c, and 411d configured to send command instructions to the far side video monitoring station 85f, and more specifically the wirelessly controlled pan and tilt mechanism 95F and the video camera 90F.

FIGS. 8A and 8B show an exterior and interior view of the near side handheld portable terminal 75n, and FIG. 9 shows a diagrammatic interior view of the same. The handheld portable terminal 75n is adapted to receive audio and video signals from the wireless video monitoring station 85f, and to transmit command instructions to the remote monitoring station 85f. Antennae 393 and 394 are coupled to the transmitter 101n and the receiver 102n, respectively. An incoming signal containing video and audio information is received and processed by a near side radio frequency (RF) receiver 102n, wherein video is displayed on a screen 76n and audio is directed to a speaker 400n.

It should be understood that the receiver 102n and transmitter 101n may be integrated to provide a transceiver 103n with the transmit and receive frequencies set converse to the transceiver 103f (see FIG. 2) such that the transceiver 103n processes an incoming RF signal received from the far side wireless video monitoring station 85f to extract a video signal and an audio signal for output via the screen 76n and speaker 400n, respectively; and to transmit command instructions inputted via, e.g., keys 411a, 411b, 411c, and 411d (possibly augmented by output from the voice recognition (“VR”) device 420n, see FIG. 9) to the far side wireless monitoring station 85f to control the pan and tilt mechanism 95f, video camera 90f, and/or microphone 110f. For example, the keys 411a and 411b may be pressed to command the pan/tilt mechanism 95f to pan right and left, respectively (see FIG. 5); and keys 411c and 411d may be pressed to command the pan/tilt mechanism to tilt up and down, respectively. An optional selector 413 may be used to selected between different video monitoring stations 85f on the mast 80.

Depending on the content of incoming signal received by the handheld portable terminal 75n, the incoming signal may, for example, be demodulated and de-multiplexed to output separate video and audio signals which are separately directed along lines 405 and 407 (FIG. 9) for output via screen 76n and electrical loudspeaker 400n, respectively. It should be understood that the loudspeaker 400n may take several forms, such as an earpiece speaker.

The handheld portable terminal 75n may comprise an optional voice recognition device 420n operably coupled to a microphone 110n. The microphone 110n picks up analog sound waves which may include speech containing command words purposefully uttered by a user, such as a coach 150. The analog microphone signal is sent along line 425 to a voice recognition device 420n to detect command words in the analog microphone signal. Detected command words are directed along line 430 to augment the output of the keypad 409 and are transmitted as an RF signal to the far side wireless video monitoring station 85f via the transmitter 101n.

The voice recognition device 420n may be of conventional design with, e.g., a processor and memory configured to detect command words in the microphone analog signal. For example, a user may utter a variety of predetermined command words; e.g., a word such as “in” may be used to signify a command instruction to cause the far side wireless video camera 90f to zoom in. The logic steps for performing the voice recognition algorithm 435 are shown in FIG. 10.

FIG. 10 shows a flow chart 435 that depicts the logic steps involved in speech recognition as performed by the voice recognition unit 420n; the terms “speech recognition” and “voice recognition” are hereinafter regarded as equivalent terms. An analog microphone signal 440 (see FIG. 10) traveling along line 425 (FIG. 9) is converted into a digital signal by an analog-to-digital (AD) converter at 445 to produce a digitized microphone signal (“DMS”) at 450, and the features of the DMS are extracted at 455 to generate extracted features at 460. The extracted DMS features are compared at 465 with features of known command words 467. When the extracted DMS features match the features of one of the stored command words 467, a command word is identified in the DMS and mapped at 470 to a command instruction (stored at 475) which is directed along line 430 (see FIG. 9) to augment the keypad output from 409N (FIG. 9) at 480.

The command words may be categorized according to target apparatus. For example, the command words “in”, “out”, “on”, and “off” are suitable for instructing the cellular video camera 90f to zoom in, zoom out, switch on, and switch off, respectively. The command words “left”, “right”, “up”, and “down” are suitable command words for controlling the pan/tilt table 95f at the far side 60. Other suitable command words are “start” and “stop” for controlling, e.g., the microphone 110f at the far side 60. However, it should be understood that the command words might vary or include additional command words without detracting from the spirit of the invention. In addition, the invention is not limited to one method of voice recognition; any suitable method of voice recognition can be used to process the analog microphone signal 440.

Cellular Enabled Video Monitoring System

In this aspect of the present invention a cellular based video monitoring system C50 (“CVMS C50”) is provided. The CVMS C50 provides video and optional audio over a long distance to a cell enabled near side portable handheld terminal 75c. The advantages and unique features of the CVMS C50 will become immediately apparent upon reading the below description of the invention.

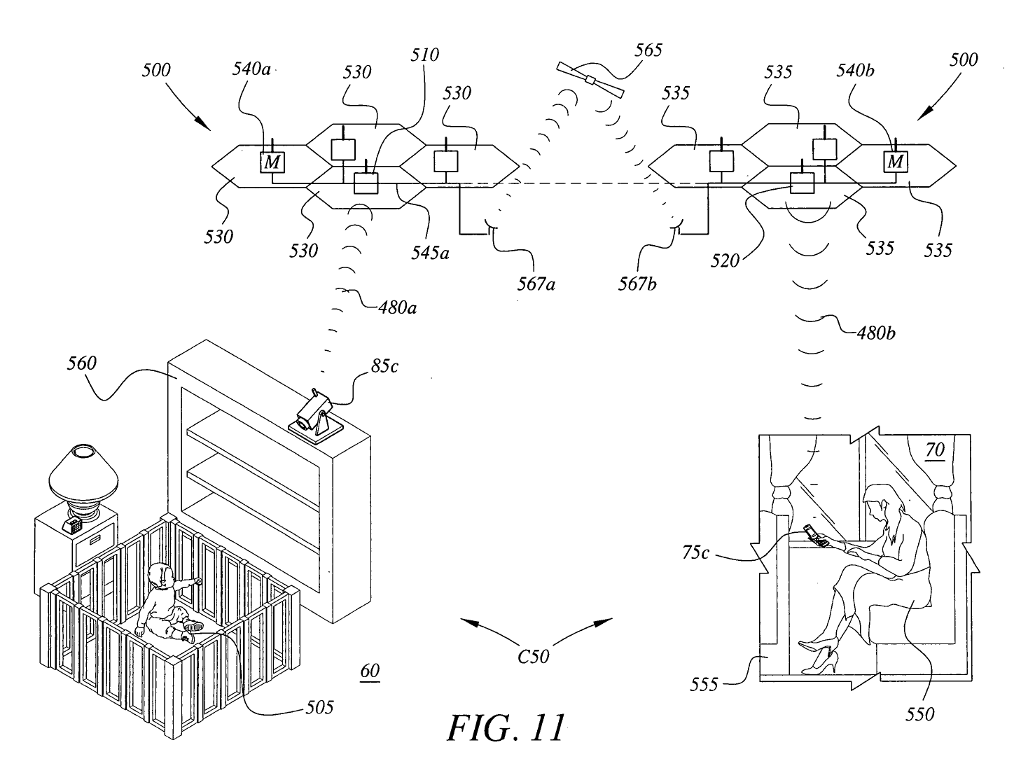

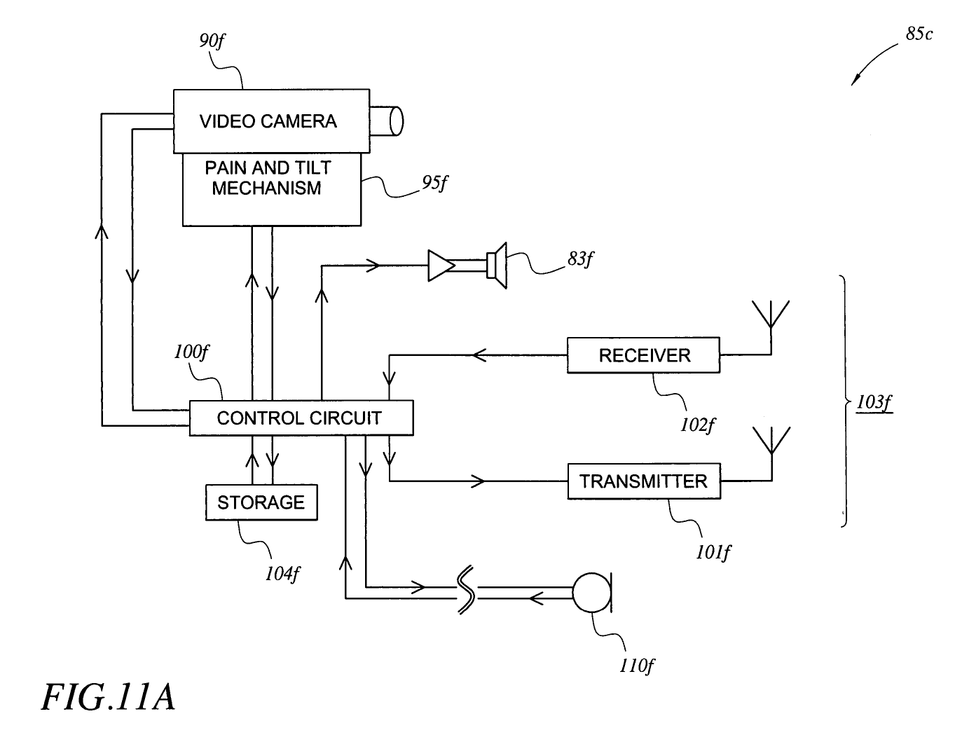

FIG. 11 shows a perspective environmental view of one embodiment of the CVMS C50. Broadly, a far side 60 cellular video monitoring station 85c transmits a video signal 480a to a near side 70 handheld portable terminal 75c via at least one cellular network, such as cell network 500. The cellular video monitoring station 85c incorporates an integrated cell phone with a cell phone number. Thus, the cellular video monitoring station 85c can be called from any location using, e.g., a cell phone with video display capability. It should be appreciated that the invention also encompasses future land phones with video display capability, i.e., phones that connect to a land line and which are adapted to display video.

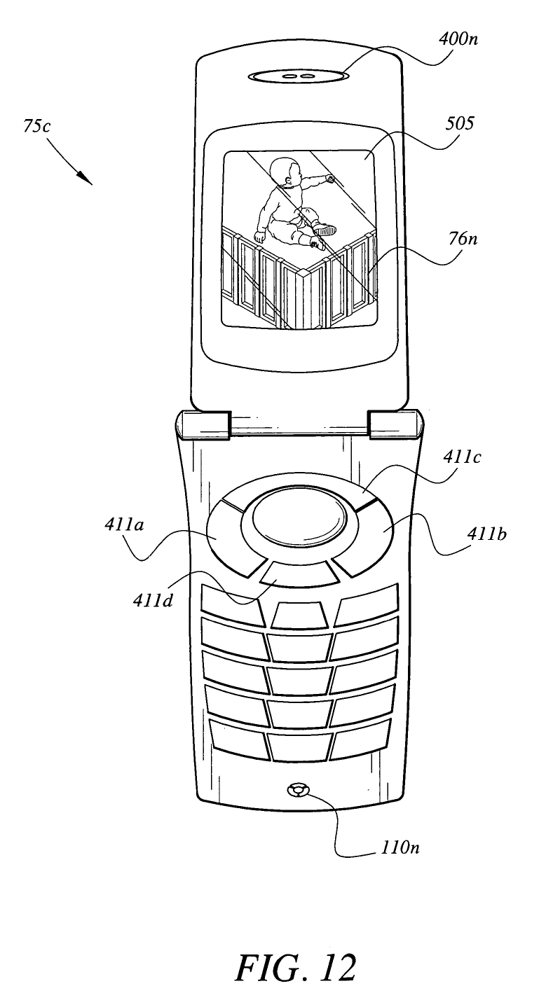

Still referring to FIG. 11, the far side 60 is a home setting with a child 505 sitting in a playpen. Specifically, the wireless video monitoring station 85c comprises a transceiver 103f (see FIG. 2) for communicating with the cell network 500; and the handheld terminal 75c is essentially a hand held cell phone with a screen 76n (see FIG. 12) capable of displaying video originating from the station 85c. (The letter “c” indicates that the devices are able to communicate to a cell network.)

The CVMS C50 is configured to transmit multimedia (e.g. video and optionally audio) using any known protocol or procedure of wireless communication including 3G (third generation) cellular technology or the like. 3G is an International Telecommunication Union specification for the third generation (1G was analog cellular, 2G was digital PCS) of mobile communications technology. When available, 3G wireless provides increased bandwidth of up to 384 Kbps when a device is stationary or moving at pedestrian speed, 128 Kbps in a car, and 2 Mbps in fixed applications. 3G works over wireless air interfaces known in the art such as WCDMA, CDMA2000 1× infrastructure solution, GSM (GPRS), and TDMA. The new EDGE (Enhanced Data for GSM Environment) air interface has been developed specifically to meet the bandwidth needs of 3G cell phones.

For example, a transceiver in the handheld portable terminal 75c (i.e. the functional equivalent of the transmitter 101N and receiver 102N combined, see FIG. 9) may be configured to operate as a high-capacity-spread-spectrum RF transmitter and receiver over a communications channel as described in U.S. Pat. No. 5,166,951 (“the '951 patent”), issued Nov. 24, 1992 to D. L. Schilling. The '951 patent is incorporated herein by reference in its entirety. Additionally, the transceiver may utilize the CDMA method as described in U.S. Pat. No. 6,449,266 B1 (“the '266 patent”), issued Sep. 10, 2002 to Hottinen et al. The '266 patent is incorporated herein by reference in its entirety.

Still referring to FIG. 11, the video station 85c communicates with a base station 510 in a first cell network 500, and the handheld portable terminal 75c with a base station in a second cell network 500. The base station 510 is one of a first plurality of base stations that define the first cell network 500; and second base station is one of a second plurality of base stations that define the second cell network 500. More specifically, each base station in the first cellular network 500 defines one of a plurality of cells 530 which further define the first cellular network 500; and each base station in the second cellular network 500 defines one of a plurality of cells 535 which further define the second cellular network 500. The size of each cell 530 and 535 depends in large part on the power rating of the corresponding base stations.

The base stations of each cell network 500 and 525 operate under the control of a mobile service-switching center 540a and 540b (“MSC 540a” and “MSC 540b”, respectively) by means of intercellular land lines 545a between the cells 530 and 535, respectively. As is well known in the art of cellular conventional cellular networks, each MSC determines which of the base stations in the cellular network 500 should process a call to the cell enabled video monitoring station 85c based on considerations such as signal strength between each available channel and the cell enabled video monitoring station 85c. Likewise the MSC 540b determines which of the base stations in cellular network 500 should process a call to the cell enabled handheld portable terminal 75c based on considerations such as signal strength between each available channel and the cellular handheld portable terminal 75c.

It should be understood that the exact configuration of a cellular networks 500 can vary, and FIG. 11 should not be viewed as constraining or limiting the present invention in any way. In addition, the cellular networks 500 may interconnect via satellite 565 and dish 567a/567b, or a cable connection (not shown). Thus, the cellular based video monitoring system C50 may be used over a considerable distance, including across state lines, continents, and international borders.

Still referring to FIG. 11, a parent 550 is shown viewing the near side cell enabled handheld portable terminal 75c while traveling on a train 555. The handheld terminal 75c is displaying video of the parent's child 505. As should now be apparent, the parent 550 can obtain near instant feedback of their child's well being by simply dialing the cell number of the cellular video monitoring station 85c. However, it should be understood that the CVMS C50 could be set up to provide video of the inside of an owner's house; thus the house owner may use the cell enabled handheld terminal 75c to obtain confirmation that, for example, an intruder is not at the owner's house.

Still referring to FIG. 11, the video monitoring station 85c is mounted on the pan and tilt mechanism 95f (see e.g. FIG. 2), which in FIG. 11 is shown located on sturdy piece of furniture 560. The video camera 90f is shown looking down on the young child 505 playing in a home setting.

Another embodiment of the cellular video monitoring station 85c is shown in FIG. 11A. In this embodiment the station 85c includes an optional far side loudspeaker 83f. The optional far side speaker 83f would allow the near side parent 550 to communicate e.g. verbal instructions or words of encouragement to their far side child 505 via the loudspeaker 83f. For the parent 550 to be heard by the child 505, the parent 550 speaks into the near side microphone 110n of their near side portable handheld terminal 75c for their words, or other parent sounds, to be outputted by speaker 83f. It should be understood that components shown in FIG. 11A such as the receiver 102f and transmitter 101f are adapted, in a manner well known in the art, to communicate with a cellular network. A parent 550 and child 505 may engaged in a two-way conversation by virtue of microphones 110f and 110n, and speakers 83f and 400n.

Video collected by the station 85c usually consists of a series of video frames. Where bandwidth is a problem, the video frames may be temporarily saved on a storage device 104f (see FIG. 2) operably coupled to the video monitoring station 85 (here 85c). JPEG compression may be used to save the video frames to the storage device 104f. JPEG compression may be used to transmit video frames regardless of bandwidth considerations. The storage device 104f may take various forms, such as electronic or magnetic media, e.g., an electronic memory chip and a conventional hard-drive, respectively.

In one embodiment, the station 85c continuously saves predetermined time intervals of video as separate files (“video files”) on the storage device 104f; as storage space on the storage device 104f is used up, the oldest files are overwritten to provide an up-to-date library of video files available to an authorized user, such as a parent 550. Thus, the parent 550 may use the handheld portable terminal 75c to dial up the video monitoring station 85c and via a suitable menu displayed on the screen 76N select a saved video file on the storage device 104f. In response to such a selection, the station 85c performs a smart download to the mobile station 75c, wherein the smart download is performed without further input from the parent. To this end, additional memory or storage 104n is provided on the handheld portable terminal 75c to store the smart download for later display on the mobile terminal's screen 76n. Thus, the parent can later see a video file of their child without the frustration of dealing with bandwidth issues prevalent with current technology cellular networks (i.e. non-3G based cellular networks). It should be understood that the term “handheld portable terminal 75c” applies to any portable or mobile video device capable of communicating with, and receiving video from, a public cellular network. Examples of such terminals include a 3G and a 2.5G cell phone. Other examples include a 3G-enabled palm held computer such as a 3G personal digital assistant (“PDA”), and a laptop computer with 3G, or the like, technology.

It should be further understood that the term “3G technology” or more simply “3G” is used herein to describe any technology available now or in the future which enables a portable terminal 75c to receive video input from any one of a plurality of geographically spaced base stations with sufficient broad band capability to handle video streaming. However, 3G availability remains patchy thus rendering a need for the smart download technology of the present invention.

It should be understood that the term “cell enabled terminal”, as used in the context of the invention, applies to any device capable of communicating with a cellular system. Examples of such mobile terminals include a cellular telephone. Other examples include any device that has been modified or designed to communicate with a cellular network including, but not limited to: a palm held computer such as a cellular enabled personal digital assistant (“PDA”), and a laptop computer with cellular connect capability.

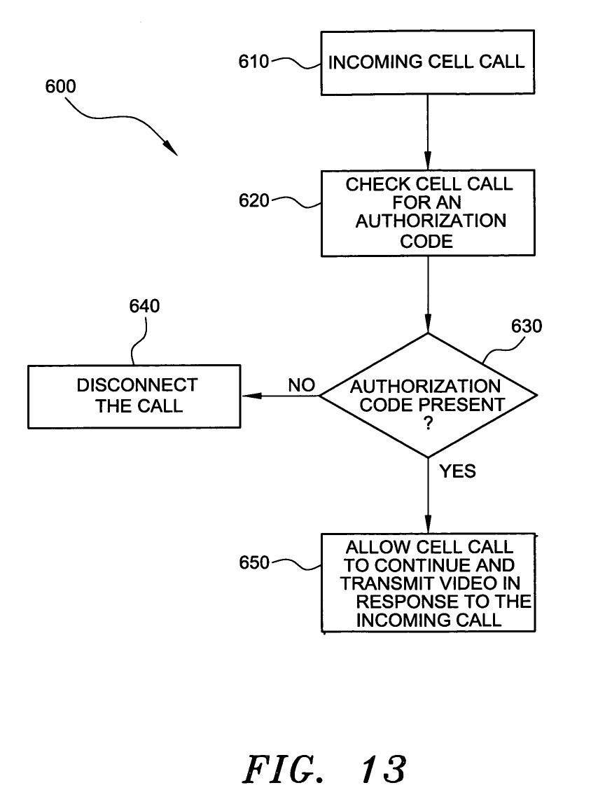

In another embodiment of the invention, an authorization protocol 600, as shown in FIG. 13, is used to ensure that only an authorized person, such as a parent, is able to view video from the video monitoring station 85c. For ease of description, the video monitoring station 85c has the components as shown in FIG. 2. The control circuit 100f is adapted to run a firewall algorithm 600. An incoming cell call is received by the transceiver 103f at 610 and the call is checked at 620 and 630 for the required authorization code. The step of checking for an authorization code may involve comparing an offered authorization code against a data base of authorization codes held in hardware memory accessible to the firewall algorithm 600. If an authorization code is identified the cell call is allowed to continue and video is transmitted in response to the cell call at 650 otherwise the call is disconnected at 640.

The authorization code may take several forms. For example, the authorization code may comprise of four digits tapped on the key board of the handheld terminal 75c, wherein the extra four digits are appended to cell phone number of the cell enabled video monitoring station 85c.

In a further embodiment of the invention a method is provided for video monitoring an area or activity that diminishes invasion of privacy and “big brother is watching you” concerns, comprising the steps of: providing an array of fixtures at pre-determined locations in an area, wherein each fixture is adapted to hold a substantially vertical mast; fitting vertical masts with opposite ends to the fixtures, wherein one mast is fitted to each the fixture, and wherein one opposite end of each mast is securely attached to each fixture and the other opposite end of the mast comprises a video monitoring system, thereby providing an array of video monitoring masts capable of video monitoring an area or an activity in the area; and removing the array of video monitoring masts from the fixtures thereby concluding the video monitoring of the area, wherein the step of removing the array of video monitoring masts serves to diminish invasion of privacy and “big brother is watching you” concerns.

The step of providing an array of fixtures may further comprise providing a plurality of pre-drilled holes at pre-determined locations in the area, wherein each of the pre-drilled holes is adapted to accommodate one of the vertical masts.

The method of video monitoring an area or activity may further comprise the step of publishing information for public consumption, wherein the published information includes a promise that the video monitoring system is of a temporary nature and will be dismantled, wherein the steps of publishing the information and removing the array of video monitoring masts serves to diminish the “big brother is watching you” concerns.

It is to be understood that the present invention is not limited to the sole embodiments described above, but encompasses any and all embodiments within the scope of the following claims.

We claim:

1. A portable wireless video system, comprising:
a mast extendable to at least 12 feet from a base to an upper end, said base including means for stabilizing said mast;
a pan and tilt mechanism mounted to said upper end of said mast;
a video camera mounted to said pan and tilt mechanism;
a remote wireless mechanism in electronic communication with said pan and tilt mechanism and said video camera, said remote wireless mechanism including a video transmitter for transmitting a video signal generated by said video camera and communicated to said remote wireless mechanism;
a portable wireless terminal having a receiver for receiving wireless transmissions originating from said remote wireless mechanism and a display for displaying sequenced images from said video signal, said portable wireless terminal also including a keypad for generating pan and tilt commands, said portable wireless terminal including a wireless transmitter for transmitting a command signal representative of said commands, said remote wireless mechanism including a receiver for receiving said command signal and controlling said pan and tilt mechanism in response to said command signal.

2. The portable wireless video system of claim 1, wherein said mast is telescopically extensible and is collapsible to about four feet in length.

3. The portable wireless video system of claim 1 wherein said mast is telescopically extensible and is extendable to at least about 20 feet in length.

4. The portable wireless video system of claim 1, further comprising a microphone in electronic communication with said remote wireless mechanism, said video transmitter also transmitting audio signals generated by said microphone.

5. The portable wireless video system of claim 4 wherein said microphone is positioned remotely from said video camera and said remote wireless mechanism.

6. The portable wireless video system of claim 1, wherein said video camera includes a standard tripod mounting adapter, said pan and tilt mechanism including a support that mates with said mounting adapter of said video camera.

7. The portable wireless video system of claim 1, further comprising a loudspeaker in electronic communication with said remote wireless mechanism and a microphone in electronic communication with said portable wireless terminal, said remote wireless mechanism receiving a wireless audio signal originating from said portable wireless terminal in response to sound being picked up by said microphone, said remote wireless mechanism amplifying said audio signal and communicating said amplified audio signal to said loudspeaker.

8. The portable wireless video system of claim 1, wherein said camera and said pan and tilt mechanism are housed in a transparent housing.

9. The portable wireless video system of claim 8, further comprising a platform at an upper end of said transparent housing, said pan and tilt mechanism being suspended from said platform within said housing.

10. The portable wireless video system of claim 1, further comprising at least one additional pan and tilt mechanism mounted to said mast, each said additional pan and tilt mechanism having a corresponding video camera mounted thereto.

11. The portable wireless video system of claim 1, wherein said means for stabilizing said mast includes a tripod stand.

12. The portable wireless video system of claim 1, wherein said means for stabilizing said mast includes a plurality of right angle tubes.

13. The portable wireless video system of claim 12, further comprising a platform supported by said plurality of right angle tubes.

14. The portable wireless video system of claim 12, further comprising a plurality of stakes for anchoring distal ends of said plurality of right angle tubes to earth.

15. The portable wireless video system of claim 12, wherein said remote wireless mechanism and said portable wireless terminal are in communication via a cellular telephone network whereby said wireless transmissions originating from said remote wireless mechanism are conveyed to said portable wireless terminal by said cellular telephone network and said command signal transmitted by said wireless transmitter is conveyed to said remote wireless mechanism by said cellular telephone network.

16. The portable wireless video system of claim 15, wherein said portable wireless terminal is a cellular telephone.

17. The portable wireless video system of claim 16, wherein said portable wireless terminal is a 3G cellular telephone.

18. A portable wireless video system comprising:
a pan and tilt mechanism;
a video camera mounted to said pan and tilt mechanism;
a remote wireless mechanism in electronic communication with said pan and tilt mechanism and said video camera, said remote wireless mechanism including a video transmitter for transmitting video signals generated by said video camera and communicated to said remote wireless mechanism;
a portable wireless terminal having a receiver for receiving wireless transmissions originating from said remote wireless mechanism and a display for displaying sequenced images from said video signal, said portable wireless terminal also including a keypad for generating pan and tilt commands, said portable wireless terminal including a wireless transmitter for transmitting a command signal representative of said commands, said remote wireless mechanism including a receiver for receiving said command signal and controlling said pan and tilt mechanism in response to said command signal; and wherein
said remote wireless mechanism and said portable wireless terminal are in communication via a cellular telephone network whereby said wireless transmissions originating from said remote wireless mechanism are conveyed to said portable wireless terminal by said cellular telephone network and said command signal transmitted by said wireless transmitter is conveyed to said remote wireless mechanism by said cellular telephone network.

19. The portable wireless video system of claim 18, wherein said portable wireless terminal is a cellular telephone.

20. The portable wireless video system of claim 19, wherein said portable wireless terminal is a 3G cellular telephone.
